(19) United States
(12) Patent Application Publication
(10) Pub. No.: US 2014/0350157 A1
(43) Pub. Date: Nov. 27, 2014

(54) COMPOSITON WITH IMPROVED SCRATCH VISIBILITY AND LOW SURFACE TACK

(71) Applicant: Borealis AG, Vienna (AT)

(72) Inventors: Georg Grestenberger, St. Peter In Der Au (AT); Klaus Bernreitner, Linz (AT); Sybille Simon, Linz (AT); Michael Reisecker, Hohenzell (AT)

(73) Assignee: Borealis AG, Vienna (AT)

(21) Appl. No.: 14/237,138

(22) PCT Filed: Aug. 8, 2012
(86) PCT No.: PCT/EP2012/065516

§ 371 Date: Apr. 7, 2014

(30) Foreign Application Priority Data
Aug. 11, 2011 (EP) 11177307.3

(51) Int. Cl. C08K 5/20; C08L 23/06; C08L 23/14; C08K 3/34; C08L 23/12

(52) U.S. Cl. CPC C08K 5/20; C08K 3/34; C08L 23/12; C08L 23/14; C08L 23/06; C08K 2201/014
USPC 524/229

(57) ABSTRACT

Composition comprising a heterophasic propylene copolymer and two different slip agents, namely—a fatty acid amid derivative of formula (I) wherein R₁ is a C₅ to C₂₅ alkyl residue or C₅ to C₂₅ alkenyl residue, R₂ is a long-chain organic residue containing at least 6 carbon atoms, and—an unsaturated fatty acid amide.

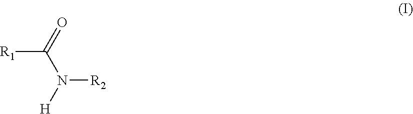

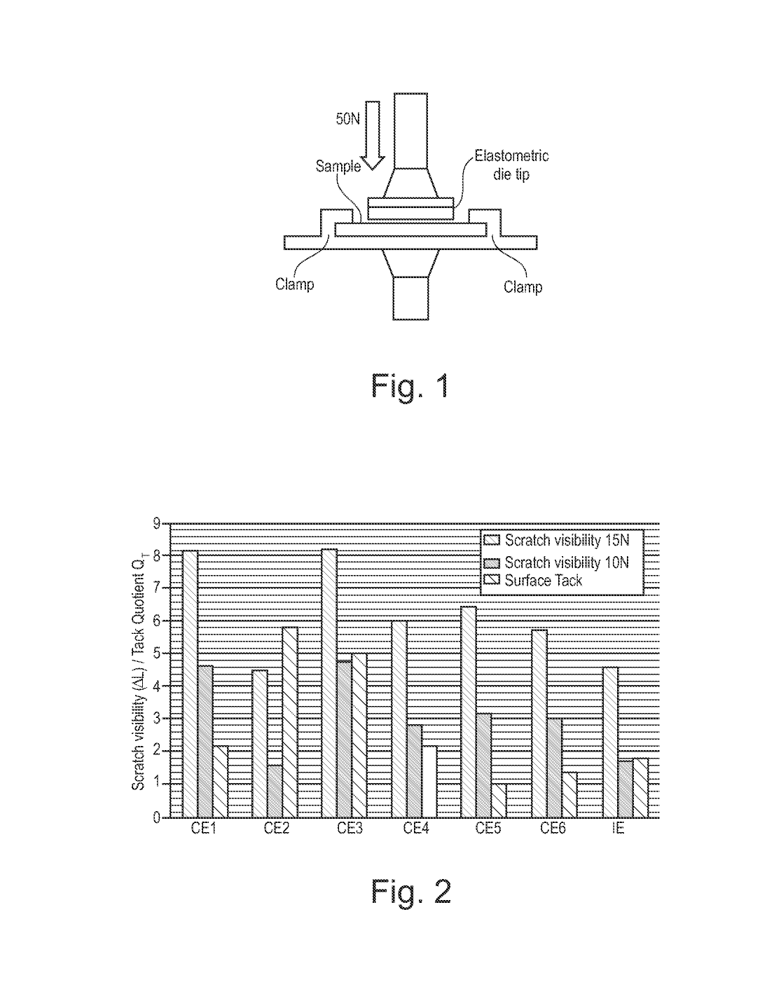

The present invention is directed to a new heterophasic propylene copolymer (HECO) composition as well as to an article comprising the HECO composition. Furthermore the present invention relates to use of the HECO composition.

Automotive interior parts like dashboards, door claddings, trims etc. are commonly made from polymers. Especially propylene based resins are widely used for these applications. For such parts it is often tried to mimic a leather- or fabric-like surface and touch in order to give occupants a high-quality impression of the car. As a result materials used should provide a low surface gloss level and good haptics. Additionally to maintain the high-quality perception of the parts till the end of the car's lifetime the polymer should provide a high resistance to scratches e.g. from keys, fingernails, rings etc.

In comparison to metals polymers have rather low stiffness and surface hardness and thus are much more prone to scratches. Therefore apart from material design and filler addition usually additives are used to overcome this drawback.

WO 2006/131455A1 discloses an additive combination that is claimed to provide improved scratch resistance to polyolefins. In particular a polyolefin composition is claimed comprising the following components

a) a polyolefin substrate and an amount effective to improve the scratch resistance and light stability of said polyolefin substrate of an additive combination of

b) a carboxylic acid reagent functionalized olefin polymer or copolymer, c) a primary or secondary fatty acid amide and d) a combination of i) a low molecular weight sterically hindered amine light stabilizer and ii) a high molecular weight sterically hindered amine light stabilizer.

It is known to people skilled in the art that scratch resistance of impact polypropylene (PP)/talc compounds can be improved by the addition of slip agents and high-density polyethylene (HDPE), e.g. compare WO 2007/139622A3, WO 02/22731A2, WO 2005/111145A1. HDPE affects the morphology of the dispersed rubber phase stabilizing the surface and immediate subsurface layer of injection moldings.

On the other hand slip agents like fatty acid amides (Erucamide, Oleamide, Stearamide, Behenamide etc.) reduce the coefficient of friction of polymeric surfaces by migrating from the bulk to the surface.

In combination both mechanisms lead to very cost efficient scratch resistant material formulations. However apart from scratch visibility and gloss also haptics is becoming more and more important for interior applications. One factor in this respect is the surface tack of a part. Unfortunately it was found that e.g. fatty acid amides in fact lead a tacky feel of the surface.

Accordingly the object of the present invention is to provide a polymer composition with improved scratch visibility and low surface tack.

The finding of the present invention is that two different slip agents must be used being not a saturated fatty acid amid.

Thus the present invention is directed to a composition comprising
(a) polyolefin, more preferably a polypropylene, still more preferably a heterophasic propylene copolymer (HECO), and
(b) two different slip agents, namely
   (b1) a fatty acid amid derivative of formula (I)

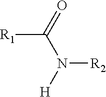

wherein
R₁ is a C₅ to C₂₅ alkyl residue or C₅ to C₂₅ alkenyl residue,
R₂ is a long-chain organic residue containing at least 6 carbon atoms, and
(b2) an unsaturated fatty acid amide, preferably a mono-unsaturated fatty acid amide.

Preferably the fatty acid amid derivative (b1) and the unsaturated fatty acid amide (b2) are the only slip agents in the composition.

The present invention discloses a simple solution to maintain the high scratch resistance and at the same time to reduce the surface tack. Surprisingly it has been found out that a combination of components (b1) and (b2) resolve the problem that on the one hand a high scratch resistance is obtained and on the other hand the surface tack is reduced.

In the following the present invention is defined in more detail.

Heterophasic Propylene Copolymer (HECO)

One essential component is the presence of a heterophasic propylene copolymer. Heterophasic polymer systems are well known in the art and are systems in particular obtained in a process comprising at least two steps resulting in a multiphase structure comprising a polypropylene matrix and inclusions therein comprising amorphous elastomer. Such systems can be easily tailored for the automotive requirements by setting the comonomer content in the polypropylene matrix and in the elastomeric phase respectively.

More precisely, a heterophasic propylene copolymer (HECO) according to this invention comprises as matrix a random propylene copolymer or a propylene homopolymer and dispersed therein an elastomeric propylene copolymer. Thus the matrix contains (finely) dispersed inclusions being not part of the matrix and said inclusions contain the elastomeric propylene copolymer. The term inclusion indicates that the matrix and the inclusion form different phases within the heterophasic propylene copolymer (HECO), said inclusions are for instance visible by high resolution microscopy, like electron microscopy or scanning force microscopy.

Preferably the heterophasic propylene copolymer (HECO) may contain further additives but no other polymer in an amount exceeding 5 wt.-%, more preferably exceeding 3 wt.-%, like exceeding 1 wt.-%, based on the total amount of the heterophasic polymer. One additional polymer which may be present in such low amounts is a polyethylene which is a reaction product obtained by the preparation of the heterophasic propylene copolymer (HECO). Accordingly it is in particular appreciated that a heterophasic propylene copolymer (HECO) as defined in the present invention contains only a polypropylene matrix, an elastomeric propylene copolymer, and optionally a polyethylene in amounts as mentioned in this paragraph.

Preferably the propylene content in the heterophasic polymer is in the range of 70 to 92 wt.-%, more preferably in the range of 75 to 85 wt.-%, yet more preferably in the range of 78 to 82 wt.-%, based on the total amount of the heterophasic propylene copolymer (HECO), more preferably based on the amount of the polymer components of the heterophasic propylene copolymer (HECO), yet more preferably based on the amount of the polypropylene matrix and the elastomeric propylene copolymer together. The remaining part constitutes the comonomers as defined for the polypropylene matrix being a random propylene copolymer and the elastomeric propylene copolymer, respectively, preferably ethylene. Accordingly the comonomer content, preferably ethylene content, for the total heterophasic propylene copolymer (HECO) is in the range of 8.0 to 30.0 wt.-%, more preferably in the range of 15.0 to 25.0 wt.-%, still more preferably in the range of 18.0 to 22.0 wt.-%, based on the total amount of the heterophasic propylene copolymer (HECO), more preferably based on the amount of the polymer components of the heterophasic propylene copolymer (HECO), yet more preferably based on the amount of the polypropylene matrix and the elastomeric propylene copolymer together.

The polypropylene matrix of the heterophasic propylene copolymer (HECO) can be made of the propylene homo- and/or copolymer only but can also comprise additional polymers, in particular polymers which can be blended homogeneously with the propylene homo- or copolymer and together form a continuous phase which can act as a matrix. In a preferred embodiment, at least 80 wt.-% of the matrix, more preferably at least 90 wt.-%, even more preferably at least 95 wt.-% of the matrix are made of the propylene homo- and/or copolymer. Even further preferred, the matrix consists of the propylene homo- and/or copolymer.

The propylene homo- and/or copolymer forming the matrix can be a random propylene copolymer or a propylene homopolymer. In a preferred embodiment, the matrix is a propylene homopolymer.

For the purpose of the present invention, the expression “propylene homopolymer” refers to a polypropylene that consists substantially, i.e. of at least 97 wt.-%, preferably of at least 98 wt.-%, more preferably of at least 99 wt.-%, most preferably of at least 99.8 wt.-% of propylene units. In a preferred embodiment only propylene units in the propylene homopolymer are detectable.

In case the propylene homo- and/or copolymer forming the matrix is a random propylene copolymer it comprises monomers copolymerizable with propylene, for example comonomers such as ethylene and/or C₄ to C₁₂ α-olefins, in particular ethylene and/or C₄ to C₁₀ α-olefins, e.g. 1-butene and/or 1-hexene. Preferably the random propylene copolymer comprises, especially consists of, monomers copolymerizable with propylene from the group consisting of ethylene, 1-butene and 1-hexene. More specifically the random propylene copolymer comprises—apart from propylene—units derivable from ethylene and/or 1-butene. In a preferred embodiment the random propylene copolymer comprises units derivable from ethylene and propylene only. The comonomer content in the random propylene copolymer is preferably in the range of more than 0.5 to 10.0 wt.-%, still more preferably in the range of more than 0.5 to 7.0 wt.-%.

The propylene homo- and/or copolymer matrix can have a xylene cold soluble content (XCS) in a broad range, i.e. up to 6.0 wt.-%, based on the total amount of propylene homo- and/or copolymer matrix. Accordingly the propylene homo- and/or copolymer matrix may have a xylene cold soluble content (XCS) in the range from 0.3 to 6.0 wt.-%, e.g., from 0.5 to 5.5 wt.-%, based on the amount of the propylene homo- and/or copolymer matrix.

According to a preferred embodiment the matrix is a propylene homopolymer having a xylene cold soluble (XCS) content in the range from 0.5 to 4.5 wt.-%, more preferably in the range from 0.8 to 4.0 wt.-%, still more preferably from 0.8 to 3.5 wt.-%.

According to one embodiment of the present invention, the polypropylene matrix has a melt flow rate MFR₂ (230° C.) of 10 to 300 g/10 min, preferably in the range from 25 to 150 g/10 min, more preferably in the range from 30 to 120 g/10 min.

Accordingly it is preferred that the propylene homo- and/or copolymer forming the matrix has a weight average molecular weight (Mw) from 100000 to 400000 g/mol, preferably from 150000 to 350000, more preferably from 175000 to 300000 g/mol.

In addition to the polypropylene matrix phase, the heterophasic propylene copolymer (HECO) comprises an elastomeric propylene copolymer which is dispersed within said matrix.

According to one embodiment, the elastomeric propylene copolymer comprises monomers copolymerizable with propylene, for example, comonomers such as ethylene and/or C₄ to C₁₂ α-olefins, preferably ethylene and/or C₄ to C₁₀ α-olefins, e.g. 1-butene and/or 1-hexene. Preferably the elastomeric propylene copolymer comprises, especially consists of, monomers copolymerizable with propylene from the group consisting of ethylene, 1-butene and 1-hexene. More specifically the elastomeric propylene copolymer comprises—apart from propylene—units derivable from ethylene and/or 1-butene. Thus, in an especially preferred embodiment the elastomeric propylene copolymer phase comprises units derivable from ethylene and propylene only.

In case the polypropylene matrix is a random propylene copolymer it is preferred that the comonomer(s) of the random propylene copolymer and the elastomeric propylene copolymer are the same.

The properties of the elastomeric propylene copolymer mainly influences the xylene cold soluble (XCS) content of the heterophasic propylene copolymer (HECO). Thus, according to the present invention the xylene cold soluble (XCS) fraction of heterophasic propylene copolymer (HECO) is regarded as the elastomeric propylene copolymer of the heterophasic propylene copolymer (HECO).

According to one embodiment of the present invention, the amount of the elastomeric propylene copolymer, i.e. of the xylene cold soluble (XCS) fraction, of the heterophasic propylene copolymer (HECO) is in the range from 15 to 50 wt.-%, preferably in the range from 20 to 40 wt.-%, and more preferably in the range from 25 to 38 wt.-%, based on the total amount of the heterophasic propylene copolymer (HECO).

A further preferred requirement of the present invention is that the intrinsic viscosity (IV) of the xylene cold soluble (XCS) fraction of the heterophasic propylene copolymer (HECO) is rather high. Rather high values of intrinsic viscosity improve the impact strength. Accordingly it is appreciated that the intrinsic viscosity of the xylene cold soluble (XCS) fraction of heterophasic propylene copolymer (HECO) is above 1.5 dl/g, more preferably at least 1.8 dl/g, yet more preferably at least 2.0 dl/g, like at least 2.3 dl/g. On the other hand the intrinsic viscosity should be not too high otherwise the flowability is decreased. Thus the intrinsic viscosity of the xylene cold soluble (XCS) fraction of the heterophasic propylene copolymer (HECO) is preferably in the range of 1.8 to 4.5 dl/g, more preferably in the range 2.0 to 4.1 dl/g, still more preferably 2.3 to 4.0 dl/g.

According to one embodiment, the heterophasic propylene copolymer (HECO) of the present invention has a rather high melt flow rate. Accordingly it is preferred that the heterophasic polymer has a melt flow rate MFR₂ (230° C.) of at least 8 g/10 min, more preferably in the range from 8 to 300 g/10 min, and most preferably in the range from 10 to 100 g/10 min, still more preferably in the range from 10 to 80 g/10 min.

Processes for preparing heterophasic polymer systems are well known in the art, and are multi-step processes containing at least two process steps. A preferred multistage process is a “loop-gas phase”-process, such as developed by Borealis A/S, Denmark (known as BORSTAR® technology) described e.g. in patent literature, such as in EP 0 887 379, WO 92/12182 WO 2004/000899, WO 2004/111095, WO 99/24478, WO 99/24479 or in WO 00/68315. A further suitable slurry-gas phase process is the Spheripol® process of Basell.

According to one embodiment of the present invention, the heterophasic propylene copolymer (HECO) is obtained by producing the polypropylene matrix phase (M) in at least one reactor, transferring said matrix phase in at least one subsequent reactor, where in presence of the matrix the elastomeric propylene copolymer is produced.

A suitable catalyst for the polymerization of the heterophasic polymer composition is any stereospecific catalyst for propylene polymerization which is capable of polymerizing and copolymerizing propylene and comonomers at a temperature of 40 to 110° C. and at a pressure from 10 to 100 bar. Ziegler-Natta as well as metallocene catalysts are suitable catalysts. One skilled in the art is aware of the various possibilities to produce such heterophasic polymers and will simply find out a suitable procedure to produce suitable heterophasic polymers which can be used in the present invention.

Especially preferred the heterophasic polypropylene is the commercial product EF 015 AE of Borealis AG.

Slip Agents

The finding of the present invention is that the composition must comprise two different specific slip agents. A slip agent according to this invention is an additive that gradually migrates to the surface and/or reduces the coefficient of friction of the surface of an article made form a composition containing said slip agent.

Accordingly it has surprisingly found out that the inventive composition must comprise

(b1) a fatty acid amid derivative of formula (I)

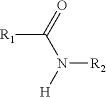

wherein

R₁ is a C₅ to C₂₅ alkyl residue or C₅ to C₂₅ alkenyl residue,

R₂ is a long-chain organic residue containing at least 6 carbon atoms, and

(b2) an unsaturated fatty acid amide, preferably a mono-unsaturated fatty acid amide.

The term “amid” (unsaturated fatty acid amide) shall indicate that the amide group is —CONH₂. In contrast to this expression the term “amide derivative” (fatty acid amid derivative) indicates that the nitrogen atom of the amide group covers organic residues (—CONHR).

The term “long-chain organic residue” covers long chain aliphatic residues, like alkyl residues and alkenyl residues, as well as aliphatic residues comprising functional groups included in the chain, like —NH—CO—, —NH—, —CO—, or —O—.

Preferably the fatty acid amid derivative of formula (I) is contained in a range between 1000 ppm to 2000 ppm, more preferred in a range 1300 ppm to 1700 ppm in the instant composition.

Preferably the unsaturated fatty acid amide is contained in a range between 1000 ppm to 2000 ppm, more preferred in a range 1300 ppm to 1700 ppm in the instant composition.

Moreover it has been found that especially good results are obtained in case a fatty acid amid derivative of formula (I) and unsaturated fatty acid amide are contained in a relation between 0.5:1.5 and 1.5:0.5, preferably in a relation between 0.8:1.3 and 1.3:0.8, more preferably in a relation of 1.0:1.0.

Fatty acids, like fatty acid amides, are known to the skilled person. Typically a fatty acid and its derivatives contain an unbranched long chain aliphatic residue. Thus according to the present invention the residues of the slip agents are unbranched. More precisely the C₅ to C₂₅ alkyl residue or C₅ to C₂₅ alkenyl residue and the specific embodiments thereof are unbranched.

The R₁ residue of the fatty acid amid derivative of formula (I) is preferably a C₁₀ to C₂₅ alkyl residue or C₁₀ to C₂₅ alkenyl residue.

The R₂ residue of the fatty acid amid derivative of formula (I) is preferably selected from the group consisting of an aliphatic amide derivative residue containing 6 to 30 carbon atoms, an aliphatic alkyl residue containing 5 to 30 carbon atoms, and an aliphatic alkeny residue containing 5 to 30 carbon atoms.

Thus in one specific embodiment the R₂ residue is a C₅ to C₂₅ alkyl residue or a C₅ to C₂₅ alkenyl residue.

In another specific embodiment the R₂ residue is R₄—NH—CO—R₅, with

R₄ being a covalent bond or a C₁ to C₆ alkyl residue, like —CH₂— or —CH₂—CH₂—, and

R₅ being a C₅ to C₂₅ alkyl residue or a C₅ to C₂₅ alkenyl residue, more preferably a C₅ to C₂₅ alkyl residue.

In one preferred embodiment the fatty acid amid derivative is of formula (Ia)

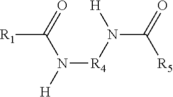

with

R₁ and R₅ being independently from each other a C₅ to C₂₅ alkyl residue, more preferably an unbranched C₅ to C₂₅ alkyl residue, still more preferably an unbranched C₁₀ to C₂₀ alkyl residue, like —(CH₂)—CH₃, with n being a positive integer between 12 to 18, like 16, and R₄ being a C₁ to C₆ alkyl residue, preferably an unbranched C₁ to C₆ alkyl residue, more preferably —CH₂— or —CH₂—CH₂—, still more preferably —CH₂—CH₂—.

It is especially preferred that R₁ and R₅ are identical and are —(CH₂)—CH₃, with n being a positive integer between 12 to 18, like 16. Accordingly in preferred embodiment the fatty acid amid derivative of formula (Ia) as stated in the previous paragraph is N,N′-bisstearoylethylenediamide (CH₃(CH₂)₁₆CONHCH₂CH₂NHCO(CH₂)₁₆CH₃).

In another preferred embodiment the fatty acid amid derivative is of formula (Ia) with

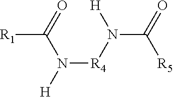

R₁ and R₅ being independently from each other a C₅ to C₂₅ alkenyl residue, more preferably an unbranched C₅ to C₂₅ alkenyl residue, still more preferably —(CH₂)ₓCH═CH(CH₂)_{y}CH₃, with x=4 to 15 and y=3 to 10, preferably with x being a positive integer between 7 to 15 and y being a positive integer between 4 to 9.

R₄ being a C₁ to C₆ alkyl residue, preferably an unbranched C₁ to C₆ alkyl residue, more preferably —CH₂— or —CH₂—CH₂—, still more preferably —CH₂—CH₂—.

It is especially preferred that R₁ and R₅ are identical and are —(CH₂)ₓCH═CH(CH₂)_{y}CH₃, with x being positive integers between 4 to 15 and y being positive integers between 3 to 10, preferably with x being a positive integer between 7 to 15 and y being a positive integer between 4 to 9. Accordingly in preferred embodiment the fatty acid amid derivative is of formula (Ib) is N,N′-ethylene-bis-oleamide.

In still another preferred embodiment the fatty acid amid derivative is of formula (Ib) with

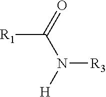

R₁ being a C₅ to C₂₅ alkyl residue, more preferably an unbranched C₅ to C₂₅ alkyl residue, still more preferably an unbranched C₁₀ to C₂₀ alkyl residue, like —(CH₂)ₙCH₃, with n being a positive integer between 12 to 18, like 14, and

R₃ being a C₅ to C₂₅ alkyl residue or C₅ to C₂₅ alkenyl residue, preferably a C₅ to C₂₅ alkenyl residue, more preferably a —(CH₂)ₓCH═CH(CH₂)_{y}CH₃, with x being a positive integer between 4 to 15 and y being a positive integer between 3 to 10, preferably with x being a positive integer between 7 to 15 and y being a positive integer between 4 to 9.

Thus it is especially preferred that

R₁ is —(CH₂)—CH₃, with n being a positive integer between 12 to 18, like 14, and

R₃ is —(CH₂)ₓCH═CH(CH₂)_{y}CH₃, with x being a positive integer between 4 to 15 and y being a positive integer between 3 to 10, preferably with x being a positive integer between 7 to 15 and y being a positive integer between 4 to 9.

Accordingly in preferred embodiment the fatty acid amid derivative of formula (Ib) is N-9-octadecenyl hexadecanamide.

In yet another preferred embodiment the fatty acid amid derivative is of formula (Ib) with

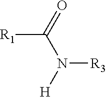

R₁ being a C₅ to C₂₅ alkenyl residue, preferably an unbranched C₅ to C₂₅ alkenyl residue, more preferably an unbranched C₁₀ to C₂₀ alkenyl residue, still more preferably —(CH₂)ₓCH═CH(CH₂)_{y}CH₃, with x a positive integer between 4 to 15 and y a positive integer between 3 to 10, preferably with x a positive integer between 7 to 15 and y a positive integer between 4 to 9,

R₃ being a C₅ to C₂₅ alkyl residue or C₅ to C₂₅ alkenyl residue, preferably a C₅ to C₂₅ alkyl residue, more preferably an unbranched C₅ to C₂₅ alkyl residue, still more preferably an unbranched C₁₀ to C₂₀ alkyl residue, like —(CH₂)—CH₃, with n a positive integer between 12 to 18, like 14.

Thus it is especially preferred that

R₁ is —(CH₂)ₓCH═CH(CH₂)_{y}CH₃, with x a positive integer between 4 to 15 and y a positive integer between 3 to 10, preferably with x a positive integer between 7 to 15 and y a positive integer between 4 to 9, and

R₃ is —(CH₂)ₙCH₃, with n a positive integer between 12 to 18, like 14.

Accordingly in preferred embodiment of the previous paragraph the fatty acid amid derivative of formula (Ib) is N-octadecyl-13-docosenamide

It is especially preferred that the fatty acid amid derivative of is of formula (Ia) and in particular is N,N′-bisstearoylethylenediamide (CH₃(CH₂)₁₆CONHCH₂CH₂NHCO(CH₂)₁₆CH₃).

But not only a fatty acid amid derivative of formula (I) must be present in the inventive composition but also an unsaturated fatty acid amide.

More preferably the unsaturated fatty acid amid is mono-unsaturated, i.e. contains only one ethylene group. Accordingly in one embodiment the unsaturated fatty acid amide is

CH₃(CH₂)ₓCH═CH(CH₂)_{y}CONH₂

with x and y being independent from each other positive integers.

more preferably CH₃(CH₂)ₓCH═CH(CH₂)_{y}CONH₂

with x and y being independent from each other positive integers.

In one preferred embodiment the x is a positive integer between 4 and 10 and/or y is a positive integer between 8 and 14, preferably x=7 and y=11.

Thus it is especially preferred that the unsaturated fatty acid amide is CH₃(CH₂)₇CH═CH(CH₂)₁₁CONH₂, i.e. erucamide.

Especially good results are achievable in case the instant composition does not contain an octadecanamide, in particular does not contain a saturated fatty acid amid. Accordingly it is especially appreciated that the fatty acid amid derivative of formula (I) [b1] and the unsaturated fatty acid amide [b2] are the only slip agents in the composition.

Additional Components

The inventive composition may additionally contain

(d) inorganic filler

and/or

(e) polypropylene homopolymer

and/or

(f) high density polyethylene (HDPE).

Also further additives know by a person skilled in the art can be contained apart from those preferably disclaimed below. One typical example of such further additive are antioxidants.

Preferably the inorganic filler is a phyllosilicate, mica or wollastonite. Even more preferred the inorganic filler is selected from the group consisting of mica, wollastonite, kaolinite, smectite, montmorillonite and talc. The most preferred the inorganic filler is talc.

The mineral filler preferably has a cutoff particle size d95 [mass percent] of equal or below 20 μm, more preferably below 10.0 μm, like below 8.0 μm.

Typically the inorganic filler has a surface area measured according to the commonly known BET method with N₂ gas as analysis adsorptive of less than 22 m²/g, more preferably of less than 20 m²/g, yet more preferably of less than 18 m²/g. Inorganic fillers fulfilling these requirements are preferably anisotropic mineral fillers, like talc, mica and wollastonite.

To improve further the stiffness of the composition for instance a propylene homopolymer and/or a high density polyethylene can be added.

Preferably the propylene homopolymer has a melt flow rate MFR₂ (230° C.) of 10.0 to 50.0 g/10 min, more preferably from 15.0 to 40.0 g/10 min.

If present, the high density polyethylene (HDPE) has preferably a density measured according to ISO 1183in the range of 0.954 to 0.966 g/cm³ and a melt flow rate (MFR₂ at 190° C.) of 1.0 to 50.0 g/10 min, more preferably from 5.0 to 40.0 g/10 min.

Composition

As mentioned above the instant composition must comprise

(a) a heterophasic propylene copolymer (HECO)

and

(b) two different slip agents, namely
(b1) a fatty acid amid derivative of formula (I)

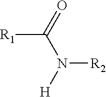

wherein
R₁ is a C₅ to C₂₅ alkyl residue or C₅ to C₂₅ alkenyl residue,
R₂ is a long-chain organic residue containing at least 6 carbon atoms, and
(b2) an unsaturated fatty acid amide, preferably a mono-unsaturated fatty acid

Optionally an inorganic filler and propylene homopolymer as well as a high density polyethylene (HDPE) can be present.

Accordingly the present invention is in particular directed to a composition comprising

Thus the present composition preferably comprises
(a) at least 40 wt.-%, more preferably 40 to 95 wt.-%, yet more preferably 45 to 75 wt.-%, of the heterophasic propylene copolymer (HECO),
(b) 1000 ppm to 2000 ppm, more preferred 1300 ppm to 1700 ppm of a fatty acid amid derivative of formula (I),
(c) 1000 ppm to 2000 ppm, more preferred 1300 ppm to 1700 ppm (mono-)unsaturated fatty acid amide, like CH₃(CH₂)ₓCH═CH(CH₂)_{y}CONH₂,
(d) optionally at least 5 wt.-%, more preferably 5 to 30 wt.-%, yet more preferably 7 to 25 wt.-%, of the inorganic filler,
(e) optionally at least 5 wt.-%, more preferably 5 to 30 wt.-%, yet more preferably 7 to 20 wt.-%, of the propylene homopolymer, and
(f) optionally at least 5 wt.-%, more preferably 5 to 30 wt.-%, yet more preferably 7 to 20 wt.-%, of the high density polyethylene (HDPE).

The composition of the present invention can be prepared by any suitable method known in the art, such as by blending the heterophasic propylene copolymer (HECO), the a fatty acid amid derivative of formula (I), the(mono-)unsaturated fatty acid amide and the additional polymer components, if present, as well as any optional further additives listed above, either directly, e.g., in an extruder, such that the same extruder is used to make the finished product, or by pre-melt mixing in a separate mixer or extruder. For mixing, a conventional compounding or blending apparatus, e.g. a Banbury mixer, a 2-roll rubber mill, Buss-co-kneader or a twin screw extruder may be used.

Furthermore the use of a composition as described above to reduce the scratch visibility and to lower the surface tack is inventive. By using the inventive material there can be obtained articles having a low surface tack and a reduced scratch visibility, what stands for difficult to see scratches in the surface of the article (see comparative examples 1 to 6 and inventive example).

Use of two different slip agents, namely a fatty acid amid derivative of formula (I) [b1] and a (mono-)unsaturated fatty acid amide [b2], like CH₃(CH₂)ₓCH═CH(CH₂)_{y}CONH₂ with x and y being independent from each other positive integers,

in a heterophasic propylene copolymer (HECO) or in a composition comprising a heterophasic propylene copolymer (HECO), to improve scratch visibility of the heterophasic propylene copolymer (HECO) or the composition comprising the heterophasic propylene copolymer (HECO),

the improvement is determined as the scratch visibility obtained by Erichsen cross hatch test and the scratch visibility of the heterophasic propylene copolymer (HECO) or the composition comprising the heterophasic propylene copolymer (HECO) comprising the two slip agents [b1] and [b2] is least 1.0 lower (at 15N) and/or at least 1.4 lower (at 10N) than the scratch visibility of the same heterophasic propylene copolymer (HECO) or the same composition comprising the heterophasic propylene copolymer (HECO) but comprising neither [b1] nor [b2] is inventive.

Preferably the scratch visibility of the instant heterophasic propylene copolymer (HECO) or the composition comprising the heterophasic propylene copolymer (HECO) comprising [b1] and [b2] is in a range between 1.2 to 1.5 lower (at 15N), more preferred in a range between 1.3 to 1.4 lower (at 15N) and/or at in a range between 1.8 to 2.2 lower (at 10N), more preferred in a range between 1.9 to 2.1 lower (at 10N) than the scratch visibility of the same heterophasic propylene copolymer (HECO) or the same composition comprising the heterophasic propylene copolymer (HECO) but comprising neither [b1] nor [b2] is inventive.

The composition of the present invention is preferably used for the production of automotive articles, like molded automotive articles, preferably automotive injection molded articles. Even more preferred is the use of the inventive composition for the production of car interiors and exteriors, like bumpers, side trims, step assists, body panels, spoilers, dashboards, interior trims and the like.

According to a preferred embodiment of the present invention, the composition of the present invention is used for the production of automotive articles, preferably interior automotive articles, more preferably dash boards, instrument panels, door claddings, arm rests, gear sticks, shift lever knobs, mats, interior skins, trunk claddings, or interior trims.

The present invention also provides (automotive) articles, like injection molded articles, comprising at least to 60 wt.-%, preferably at least 80 wt.-%, more preferably at least 95 wt.-%, and most preferably consisting of the inventive composition. Accordingly the present invention is especially directed to automotive articles, especially to car interiors and exteriors, like bumpers, side trims, step assists, body panels, spoilers, dashboards, interior trims and the like, comprising at least to 60 wt.-%, preferably at least 80 wt.-%, more preferably at least 95 wt.-%, and most preferably consisting of the inventive composition.

According to a preferred embodiment of the present invention, the automotive article is an interior automotive article, more preferably a dash board, instrument panel, door cladding, arm rest, gear stick, shift lever knob, mat, interior skin, trunk cladding, or interior trim.

The present invention will now be described in further detail by the examples provided below.

### EXAMPLE

### 1. Measuring Methods

The following definitions of terms and determination methods apply for the above general description of the invention as well as to the below examples unless otherwise defined. The Density was measured according to ISO 1183-1—method A (2004). Sample preparation is done by compression moulding in accordance with ISO 1872-2:2007.

The ethylene content was measured with Fourier transform infrared spectroscopy (FTIR) calibrated with ¹³C-NMR. When measuring the ethylene content in polypropylene, a thin film of the sample (thickness about 250 μm was prepared by hot-pressing. The area of absorption peaks 720 and 733 cm⁻¹ was measured with Perkin Elmer FTIR 1600 spectrometer. The method was calibrated by ethylene content data measured by ¹³C-NMR.

Molecular Weights, Molecular Weight Distribution (Mn, Mw, MWD)

Mw/Mn/MWD were measured by Gel Permeation Chromatography (GPC) according to the following method:

The weight average molecular weight Mw and the molecular weight distribution (MWD=Mw/Mn wherein Mn is the number average molecular weight and Mw is the weight average molecular weight) is measured by a method based on ISO 16014-1:2003 and ISO 16014-4:2003. A Waters Alliance GPCV 2000 instrument, equipped with refractive index detector and online viscosimeter was used with 3× TSK-gel columns (GMHXL-HT) from TosoHaas and 1,2,4-trichlorobenzene (TCB, stabilized with 200 mg/L 2,6-Di tert butyl-4-methyl-phenol) as solvent at 145° C. and at a constant flow rate of 1 mL/min. 216.5 μL of sample solution were injected per analysis. The column set was calibrated using relative calibration with 19 narrow MWD polystyrene (PS) standards in the range of 0.5 kg/mol to 11 500 kg/mol and a set of well characterised broad polypropylene standards. All samples were prepared by dissolving 5-10 mg of polymer in 10 mL (at 160° C.) of stabilized TCB (same as mobile phase) and keeping for 3 hours with continuous shaking prior sampling in into the GPC instrument.

The MFR₂ (230° C.) was measured according to ISO 1133 (230° C., 2.16 kg load).

The MFR₂ (190° C.) was measured according to ISO 1133 (190° C., 2.16 kg load).

The content of xylene cold solubles (XCS, wt.-%) was determined at 25° C. according ISO 16152; first edition; 2005-07-01.

The gloss was measured on injection moulded grained specimen according to DIN 67530 at an angle of 60°. The grain for gloss measurements was identical to the grain used in evaluation of scratch visibility.

Particle size is measured according to ISO 13320-1:1999

The intrinsic viscosity was measured according to DIN ISO 1628/1, October 1999 (in decalin at 135° C.).

The tensile modulus was measured according to ISO 527-2 (cross head speed=1 mm/min; 23° C.) using injection moulded specimens as described in EN ISO 1873-2 (dog bone shape, 4 mm thickness).

Scratch Visibility

To determine the scratch visibility a Cross Hatch Cutter Model 420P, manufactured by Erichsen, was used. For the tests, plaques of 70×70×4 mm size were cut from a moulded grained (grain parameters: average grain size=1 mm, grain depth=0.12 mm, conicity=6°) plaque of size 140×200×4 mm. The period between injection moulding of specimens and scratch-testing was 7 days.

For testing the specimens must be clamped in a suitable apparatus as described above. Scratches were applied at a force of 10 N or 15 N using a cylindrical metal pen with a ball shaped end (radius=0.5 mm±0.01). A cutting speed of 1000 mm/min was used.

A minimum of 20 scratches parallel to each other were brought up at a load of 10 N with a distance of 2 mm. The application of the scratches was repeated perpendicular to each other, so that the result was a scratching screen. The scratching direction should be unidirectional.

The scratch visibility is reported as the difference of the luminance ΔL of the unscratched from the scratched areas. ΔL values were measured using a spectrophotometer that fulfils the requirements to DIN 5033. Light source for quantification of ΔL D65/10°. Measured ΔL values must be below a maximum of 1.5.

A detailed test description of the test method (Erichsen cross hatch cutter method) can be found in the article “Evaluation of scratch resistance in multiphase PP blends” by Thomas Koch and Doris Machl, published in POLYMER TESTING 26 (2007), p. 927-936.

Surface Tack

The surface tack measurement was performed on injection moulded multigrain plaques with a film gate using the grain K29. The K29 surface is defined as a grain with a grain depth of 0.01 mm, and a minimum draft angle of 1° for ejection from the injection moulding tool. The section with this grain was cut out from the plaque with a bench shear.

To perform the experiments an Instron tensile testing machine was used (ElectroPuls E3000, Instron Deutschland GmbH, Germany) with an elastomer die tip having a diameter of 25 mm and a thickness of 5 mm. The compressive force F was −50 N, the holding time t_{H} was 91 s, and the haul-off speed v was 55 mm/s. The tests were performed at standard laboratory climate conditions (23° C. and 50% relative humidity). Each single surface tack measurement was performed with this setup in the following way: After the elastomer (NR/SBR) tip had been cleaned and attached to the die by means of a double-side adhesive tape, the tackiness force F_{T} of both the aluminium reference and the specimen (sample) were measured. The surface tack is reported as tack quotient Q_{T}, which was calculated by the following Equation:

$${Q}_{T} = \frac{{F}_{T , sample}}{{F}_{T , reference}}$$

and averaged over a minimum of three successive measurements.

A detailed description of the test method for quantifying surface tack can also be found in the paper “A novel test method for quantifying surface tack of polypropylene compound surfaces” by [symbol] akmak et al., which will be published in eXPRESS Polymer Letters in 2011.

### 2. Examples

One polymer compositions according to the present invention (IE: inventive example) and six comparative compositions (CE: comparative examples) were prepared. The components of the compositions are listed in Table 1. The polymer compositions were prepared by melt blending the components on a co-rotating twin screw extruder type Coperion ZSK 40 (screw diameter 40 mm, L/D ratio 38) at temperatures in the range of 170-190° C., using a high intensity mixing screw configuration with two sets of kneading blocks.

TABLE 1
Compositions

| | unit | C1 | C2 | C3 | C4 | C5 | C6 | IE1 |
|---|---|---|---|---|---|---|---|---|
| H-PP | [wt.-%] | 59 | 57.8 | 57.8 | 57.8 | 57.8 | 57.8 | 57.8 |
| talc | [wt.-%] | 17 | 17 | 17 | 17 | 17 | 17 | 17 |
| PP | [wt.-%] | 12 | 12 | 12 | 12 | 12 | 12 | 12 |
| HDPE | [wt.-%] | 11 | 11 | 11 | 11 | 11 | 11 | 11 |
| ESA | [wt.-%] | — | 0.3 | — | — | — | 0.1 | 0.15 |
| FA6 | [wt.-%] | — | — | 0.3 | — | 0.15 | 0.1 | 0.15 |
| SR | [wt.-%] | — | — | — | 0.3 | 0.15 | 0.1 | — |

* the remaining part to 100 wt.-% are antioxidants and colorants
H-PP is the commercial heterophasic propylene copolymer “EF015AE” of Borealis AG having a melt flow rate MFR₂ (230° C.) of 18 g/10 min, a XCS of 29 wt.-%, and an ethylene content (C2) of 20 wt.-%,
Talc is the commercial product “Steamic T1 CA” of Luzenac having a median particle size d50 of 2.1 μm.
PP is the commercial propylene homopolymer “HF955MO” of Borealis AG having a melt flow rate MFR₂ (230° C.) of 20 g/10 min,
HDPE is the commercial high density polyethylene “MG9641B” of Borealis AG having a melt flow rate MFR₂ (190° C.) of 8 g/10 min and a density of 964 kg/m³,
ESA is the commercial erucamide “Finawax-E” of Fine Organics,
FA6 is the commercial NN′-bisstearoylethylenediamide “Licolub FA6” of Clariant,
SR is the commercial stearamide “Cordamide SR” of Croda Chemical

TABLE 2
Properties

| | unit | C1 | C2 | C3 | C4 | C5 | C6 | IE |
|---|---|---|---|---|---|---|---|---|
| MFR₂ | [g/10 min] | 13.1 | 15.7 | 13.8 | 14.0 | 14.7 | 14.3 | 13.5 |
| Tensile modulus | [MPa] | 1769 | 1655 | 1752 | 1740 | 1732 | 1682 | 1732 |
| Gloss | [%] | 3.2 | 3.3 | 3.4 | 3.3 | 3.3 | 3.4 | 3.4 |
| Surface Tack | [—] | 2.1 | 5.8 | 5.0 | 2.2 | 1.0 | 1.4 | 1.9 |
| Scratch visibility (10 N) | [—] | 4.6 | 1.6 | 4.8 | 2.8 | 3.2 | 3.1 | 1.8 |
| Scratch visibility (15 N) | [—] | 8.2 | 4.5 | 8.2 | 6.0 | 6.4 | 5.7 | 4.6 |

It was found that the combination of ESA (Erucamide) and FA 6 ((N,N′-Bisstearoyl-ethylenediamide) gives a similar scratch performance than the same amount of Erucamide but considerable lower surface tack. Although with other combinations the surface tack could be decreased even further the combination of ESA and FA6 gave the best balance between surface tack and scratch resistance. Furthermore no markedly negative influence on surface gloss or mechanics was observed.

1. Composition comprising:
(a) a heterophasic propylene copolymer (HECO),
(b) two different slip agents, namely
(b1) a fatty acid amid derivative of formula (I); 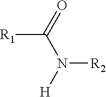
wherein
R₁ is a C₅ to C₂₅ alkyl residue or C₅ to C₂₅ alkenyl residue,
R₂ is a long-chain organic residue containing at least 6 carbon atoms, and
(b2) an unsaturated fatty acid amide.

2. Composition according to claim 1, wherein the fatty acid amid derivative is of formula (Ia): 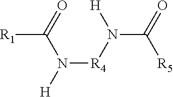
with
R₁ and R₅ being independently from each other a C₅ to C₂₅ alkyl residue,
R₄ being a C₁ to C₆ alkyl residue.

3. Composition according to claim 1, wherein the fatty acid amid derivative of formula (Ia) is N,N′-bisstearoylethylenediamide.

4. Composition according to claim 1, wherein the unsaturated fatty acid amide is CH₃(CH₂)xCH═CH(CH₂)_{y}CONH₂, with x and y being independent from each other positive integers.

5. Composition according to claim 1, wherein x is a positive integer between 4 and 10 and/or y is a positive integer between 8 and 14.

6. Composition according to claim 1, wherein the fatty acid amid derivative of formula (I) and the unsaturated fatty acid amide are contained in a relation between 0.5:1.5 and 1.5:0.5.

7. Composition according to claim 1, wherein the fatty acid amid derivative of formula (Ia) and the unsaturated fatty acid amide are the only slip agents in the composition.

8. Composition according to claim 1, wherein the composition comprises the fatty acid amid derivative of formula (I) and the unsaturated fatty acid amide in a range of 1000 ppm to 2000 ppm.

9. Composition according to claim 1, wherein the composition comprises additionally;
(c) talc and/or
(d) polypropylene homopolymer and/or
(e) high density polyethylene (HDPE).

10. Article comprising a composition according to claim 1.

11. Article according to claim 10, wherein the article is an automotive part.

12-13. (canceled)

14. The article of claim 10, wherein the composition is provided in the article at an amount effective to reduce the scratch visibility and/or to lower the surface tack of the article.

15. A heterophasic propylene copolymer (HECO) comprising amounts of a fatty acid amid derivative of formula (I) [b1] and a unsaturated fatty acid amide [b2] effective to improve scratch visibility of the heterophasic propylene copolymer (HECO),
the improvement is determined as the scratch visibility obtained by Erichsen cross hatch test and the scratch visibility of the heterophasic propylene copolymer (HECO) comprising [b1] and [b2] is least 1.0 lower (at 15N) and/or at least 1.4 lower (at 10N) than the scratch visibility of the same heterophasic propylene copolymer (HECO) but comprising neither [b1] nor [b2].
